(19) United States
(12) Patent Application Publication
(10) Pub. No.: US 2015/0310093 A1
(43) Pub. Date: Oct. 29, 2015

(54) METHOD OF PROVIDING CONTENTS OF AN ELECTRONIC DEVICE

(71) Applicant: Samsung Electronics Co., Ltd., Gyeonggi-do (KR)

(72) Inventors: Sunok KIM, Busan (KR); Hyunkyoung KIM, Seoul (KR); Yohan LEE, Gyeonggi-do (KR); Hyeran PARK, Gyeonggi-do (KR); Hokyung PARK, Seoul (KR)

(73) Assignee: Samsung Electronics Co., Ltd.

(21) Appl. No.: 14/695,906

(22) Filed: Apr. 24, 2015

(30) Foreign Application Priority Data
Apr. 24, 2014 (KR) 10-2014-0049615

(51) Int. Cl. G06F 17/30

(52) U.S. Cl. CPC G06F 17/30601

(57) ABSTRACT

An electronic device that uses a method of providing contents by an electronic device is provided. The method includes analyzing at least one element of log information, generating at least one emotion content and at least one log content based on the analyzed at least one element of log information, determining whether there are emotion contents generated based on the log information of the at least one log content, generating at least one combined content by using the at least one log content and the determined emotion contents, and grouping the at least one log content and the at least one combined content, and displaying at least one content group.

### PRIORITY

This application claims priority under 35 U.S.C. §119(a) to Korean Patent Application Ser. No. 10-2014-0049615, which was filed in the Korean Intellectual Property Office on Apr. 24, 2014, the entire disclosure of which is incorporated herein by reference.

### BACKGROUND OF THE INVENTION

1. Field of the Invention

The present invention relates generally to a method of providing contents of an electronic device, and more particularly, to an electronic device which uses a method that allows a user to view a history of the user's past use of the electronic device.

2. Description of the Prior Art

A portable terminal can be configured to allow a user to perform various functions. e.g., for performing various telephone functions, for sending and receiving messages, for photography including video photography, for playing media, for Social Network Services (SNS), for health management, for games, for watching and listening to broadcasting, and for scrap booking. The portable terminal may generate or download various histories or contents while performing the aforementioned functions.

Further, it may be desirable to provide a user with the capability of being able to view a history of the user's past use of terminal.

### SUMMARY OF THE INVENTION

The present invention has been made to address at least the above mentioned problems and/or disadvantages and to provide at least the advantages described below.

An aspect of the present invention provides an electronic device and a method of providing contents, which are capable of generating and displaying various contents showing the past of a user of the electronic device and an emotional state at a specific time in the user's past.

According to an aspect of the present invention, an electronic device and method of providing contents generate log contents showing a past history of a user by using log information.

According to an aspect of the present invention, an electronic device and method of providing contents generate emotion contents showing an emotional state of a user by using log information.

According to an aspect of the present invention, an electronic device and method of providing contents generate emotion contents showing the past and emotion of a user by combining log contents and emotion contents.

According to an aspect of the present invention, an electronic device and method for providing contents display a content group, in which combined contents are grouped, in various forms.

According to an aspect of the present invention, a method of providing contents by an electronic device is provided. The method includes analyzing at least one element of log information, generating at least one emotion content and at least one log content based on the analyzed at least one element of log information, determining whether there are emotion contents generated based on the log information of the at least one log content, generating at least one combined content by using the at least one log content and the determined emotion contents, and grouping the at least one log content and the at least one combined content, and displaying at least one content group.

According to another aspect of the present invention, an electronic device is provided. The electronic device includes a processor configured to analyze at least one element of log information and generate at least one log content and at least one emotion content, combine the generated at least one emotion content based on the log information of the at least one log content, generate at least one combined content including emotion contents, group the at least one log content and the at least one combined content, generate a content group, generate group emotion contents by using emotion contents included in the generated content group, and insert the generated group emotion contents into the generated content group in the form of log contents, and a display module configured to display the generated content group including the generated group emotion contents on the display module.

According to another aspect of the present invention, a non-transitory computer readable medium is provided, having computer-executable instructions which, when executed by a processor, cause a processing system to perform a method of providing contents that have been recorded on an electronic device. The method includes analyzing at least one element of log information, generating at least one emotion content and at least one log content based on the analyzed at least one element of log information, determining whether there are emotion contents generated based on the log information of the least one log content, generating at least one combined content by using the at least one log content and the determined emotion contents, and grouping the at least one log content and the at least one combined content and displaying at least one content group.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating a network environment including an electronic device, according to an embodiment of the present invention;

FIG. 2 is a block diagram illustrating an electronic device, according to an embodiment of the present invention;

FIG. 3 is a flowchart illustrating a method of providing contents by an electronic device, according to an embodiment of the present invention;

FIGS. 4A-4C are diagrams illustrating a method of providing contents by an electronic device, according to an embodiment of the present invention;

FIG. 5 is a diagram illustrating an example in which content groups are displayed, according to an embodiment of the present invention; and

FIGS. 6A and 6B are diagrams illustrating an example of images in which a change in an emotion level is displayed in a graph, according to an embodiment of the present invention.

### DETAILED DESCRIPTION OF THE EMBODIMENTS OF THE PRESENT INVENTION

Hereinafter, embodiments of the present invention are described in detail with reference to the accompanying drawings. Those of ordinary skill in the art will recognize that various changes and modifications of the embodiments described herein can be made without departing from the scope of the present invention. In addition, descriptions of well-known functions and constructions may be omitted for clarity and conciseness. The same reference symbols are used throughout the drawings to refer to the same or like parts.

It should be noted that various embodiments described below may be applied or used individually or in combination.

The following description with reference to the accompanying drawings is provided to assist in a comprehensive understanding of various embodiments of the present invention as defined by the claims and their equivalents. It includes various specific details to assist in that understanding but these are to be regarded as merely examples. Accordingly, those of ordinary skill in the art will recognize that various changes and modifications of the embodiments described herein can be made without departing from the scope and spirit of the present invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present invention. Accordingly, it should be apparent to those skilled in the art that the following description of various embodiments of the present invention is provided for illustrative purpose only and not for the purpose of limiting the present invention as defined by the appended claims and their equivalents.

As used herein, the singular forms “a”, “an”, and “the” are intended to include the plural forms, including “at least one”, unless the content clearly indicates otherwise. “Or” means “and/or”. As used herein, the term “and/or” includes any and all combinations of one or more of the associated listed items. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms “first”, “second”, “third”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element”, “component”, “region”, “layer” or “section” discussed below could be termed a second element, component, region, layer or section without departing from the teachings herein.

The term “module” used in this disclosure may refer to a certain unit that includes one of hardware, software and firmware or any combination thereof. The module may be interchangeably used with unit, logic, logical block, component, or circuit, for example. The module may be the minimum unit, or part thereof, which performs one or more particular functions. The module may be formed mechanically or electronically. For example, the module disclosed herein may include at least one of Application-Specific Integrated Circuit (ASIC) chip, Field-Programmable Gate Arrays (FPGAs), and programmable-logic device, which have been known or are to be developed.

An electronic device may be a device that involves a communication function. For example, an electronic device may be a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), an MP3 player, a portable medical device, a digital camera, or a wearable device (e.g., an Head-Mounted Device (HMD) such as electronic glasses, electronic clothes, an electronic bracelet, an electronic necklace, an electronic appcessory, or a smart watch).

An electronic device may be a smart home appliance that involves a communication function. For example, an electronic device may be a TV, a Digital Video Disk (DVD) player, audio equipment, a refrigerator, an air conditioner, a vacuum cleaner, an oven, a microwave, a washing machine, an air cleaner, a set-top box, a TV box (e.g., Samsung HomeSync™, Apple TV™, Google TV™, etc.), a game console, an electronic dictionary, an electronic key, a camcorder, or an electronic picture frame.

An electronic device may be a medical device (e.g., Magnetic Resonance Angiography (MRA), Magnetic Resonance Imaging (MRI), Computed Tomography (CT), ultrasonography, etc.), a navigation device, a Global Positioning System (GPS) receiver, an Event Data Recorder (EDR), an Flight Data Recorder (FDR), a car infotainment device, electronic equipment for ship (e.g., a marine navigation system, a gyrocompass, etc.), avionics, security equipment, or an industrial or home robot.

An electronic device may be furniture or part of a building or construction having a communication function, an electronic board, an electronic signature receiving device, a projector, or various measuring instruments (e.g., a water meter, an electric meter, a gas meter, a wave meter, etc.). An electronic device disclosed herein may be one of the above-mentioned devices or any combination thereof. As well understood by those skilled in the art, the above-mentioned electronic devices are exemplary only and not to be considered as a limitation of this disclosure.

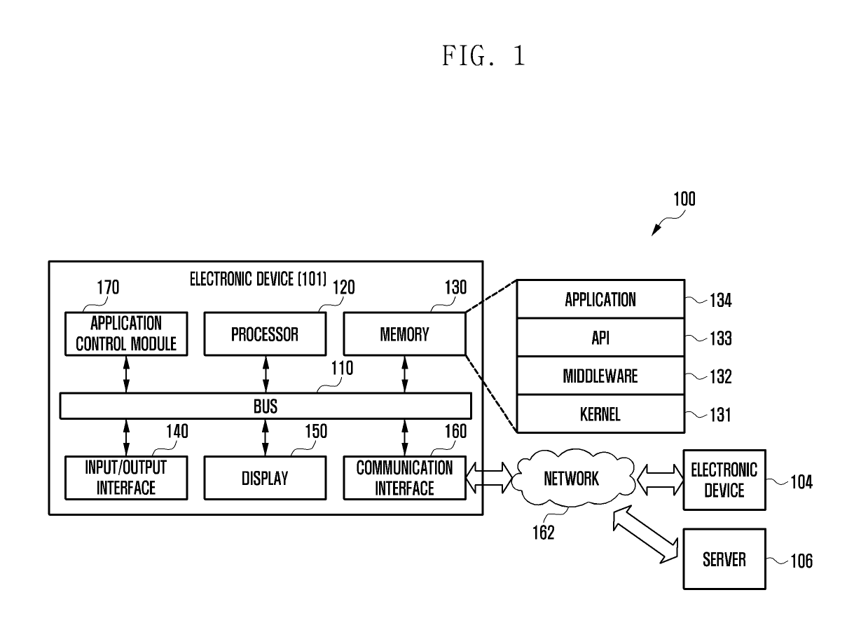

FIG. 1 is a block diagram illustrating a network environment including an electronic device 100, according to an embodiment of the present invention.

Referring to FIG. 1, the electronic device 100 includes, but is not limited to, a bus 110, a processor 120, a memory 130, an input/output interface 140, a display 150, a communication interface 160, and an application control module 170.

The bus 110 may be a circuit designed for connecting the above-discussed elements and communicating data (e.g., a control message) between such elements.

The processor 120 receives commands from the other elements (e.g., the memory 130, the input/output interface 140, the display 150, the communication interface 160, or the application control module 170, etc.) through the bus 110, interprets the received commands, and performs the arithmetic or data processing based on the interpreted commands.

The memory 130 stores therein commands or data received from or created at the processor 120 or other elements (e.g., the input/output interface 140, the display 150, the communication interface 160, or the application control module 170, etc.).

The memory 130 includes programming modules such as a kernel 131, a middleware 132, an application programming interface (API) 133, and an application 134. Each of the programming modules may be composed of software, firmware, hardware, and any combination thereof.

The kernel 131 controls or manages system resources (e.g., the bus 110, the processor 120, or the memory 130, etc.) used for performing operations or functions of the other programming modules, e.g., the middleware 132, the API 133, or the application 134. Additionally, the kernel 131 may offer an interface that allows the middleware 132, the API 133 or the application 134 to access, control or manage individual elements of the electronic device 101.

The middleware 132 performs intermediation by which the API 133 or the application 134 communicates with the kernel 131 to transmit or receive data. Additionally, in connection with task requests received from the applications 134, the middleware 132 performs a control (e.g., scheduling or load balancing) for the task request by using technique such as assigning the priority for using a system resource of the electronic device 101 (e.g., the bus 110, the processor 120, or the memory 130, etc.) to at least one of the applications 134.

The API 133, which is an interface for allowing the application 134 to control a function provided by the kernel 131 or the middleware 132, may include, for example, at least one interface or function (e.g., a command) for a file control, a window control, an image processing, a text control, and the like.

The application 134 may include an SMS/MMS application, an email application, a calendar application, an alarm application, a health care application (e.g., an application for measuring quantity of motion or blood sugar), an environment information application (e.g., an application for offering information about atmospheric pressure, humidity, or temperature, etc.), and the like. Additionally or alternatively, the application 134 may be an application associated with an exchange of information between the electronic device 100 and any external electronic device (e.g., an external electronic device 104). This type application may include a notification relay application for delivering specific information to an external electronic device, or a device management application for managing an external electronic device.

For example, the notification relay application may include a function to deliver notification information created at any other application of the electronic device 100 (e.g., the SMS/MMS application, the email application, the health care application, or the environment information application, etc.) to an external electronic device (e.g., the electronic device 104). Additionally or alternatively, the notification relay application may receive notification information from an external electronic device (e.g., the electronic device 104) and offer it to a user. The device management application may manage (e.g., install, remove or update) a certain function (a turn-on/turn-off of an external electronic device (or some components thereof), or an adjustment of brightness (or resolution) of a display) of any external electronic device (e.g., the electronic device 104) communicating with the electronic device 100, a certain application operating at such an external electronic device, or a certain service (e.g., a call service or a message service) offered by such an external electronic device.

The application 134 may include a specific application specified depending on attributes (e.g., a type) of an external electronic device (e.g., the electronic device 104). For example, in case an external electronic device is an MP3 player, the application 134 may include a specific application associated with a play of music. Similarly, if the external electronic device is a portable medical device, the application 134 may include a specific application associated with a health care. The application 134 may include at least one of an application assigned to the electronic device 100 or an application received from an external electronic device (e.g., the server 106 or the electronic device 104).

The input/output interface 140 delivers commands or data, entered by a user through an input/output unit (e.g., a sensor, a keyboard, or a touch screen), to the processor 120, the memory 130, the communication interface 160, or the application control module 170 via the bus 110. For example, the input/output interface 140 may offer data about a user's touch, entered through the touch screen, to the processor 120. Also, through the input/output unit (e.g., a speaker or a display), the input/output interface 140 may output commands or data, received from the processor 120, the memory 130, the communication interface 160, or the application control module 170 via the bus 110. For example, the input/output interface 140 may output voice data, processed through the processor 120, to a user through the speaker.

The display 150 displays thereon various kinds of information (e.g., multimedia data, text data, etc.) to a user.

The communication interface 160 provides a communication interface between the electronic device 100 and any external electronic device (e.g., the electronic device 104 of the server 106). For example, the communication interface 160 may provide a communication interface so that the electronic device 100 can communicate with any external device via a network 162, through a wired or wireless communication. A wireless communication may include, but not limited to, at least one of Wireless Fidelity (WiFi), Bluetooth (BT), Near Field Communication (NFC), GPS, or a cellular communication (e.g., LTE, LTE-A, CDMA, WCDMA, UMTS, WiBro, or GSM, etc.). A wired communication may include, but not limited to, at least one of Universal Serial Bus (USB), High Definition Multimedia Interface (HDMI), Recommended Standard (RS)-232, or Plain Old Telephone Service (POTS).

The network 162 may be a communication network, which may include at least one of a computer network, an internet, an Internet of things, or a telephone network. A protocol (e.g., transport layer protocol, data link layer protocol, or physical layer protocol) for a communication between the electronic device 100 and any external device may be supported by at least one of the application 134, the API 133, the middleware 132, the kernel 131, or the communication interface 160.

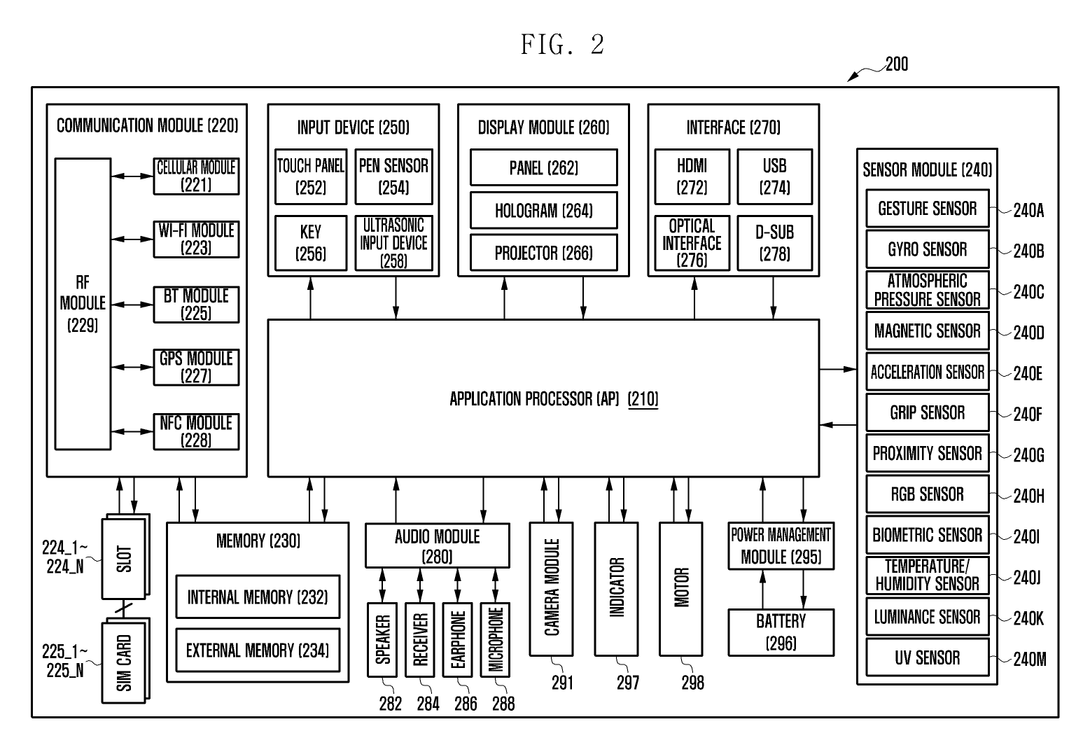

The application control module 170 processes at least part of information obtained from the other elements (e.g., the processor 120, the memory 130, the input/output interface 140, or the communication interface 160, etc.) and then offers it to a user in various ways. For example, the application control module 170 recognizes information about access components equipped in the electronic device 100, stores such information in the memory 130, and executes the application 134 on the basis of such information. A further description about the application control module 170 will be given hereinafter through FIGS. 2-6.

FIG. 2 is a block diagram illustrating an electronic device 200, according to an embodiment of the present invention.

The electronic device 200 may form, for example, the whole or part of the electronic device 100 shown in FIG. 1. Referring to FIG. 2, the electronic device 200 includes at least one application processor (AP) 210, a communication module 220, a subscriber identification module (SIM) card 224, a memory 230, a sensor module 240, an input unit 250, a display 260, an interface 270, an audio module 280, a camera module 291, a power management module 295, a battery 296, an indicator 297, and a motor 298.

The AP 210 drives an operating system or applications, controls a plurality of hardware or software components connected thereto, and also performs processing and operation for various data including multimedia data. The AP 210 may be formed of system-on-chip (SoC), for example. The AP 210 may further include a graphic processing unit (GPU).

The AP 210 generates log contents and emotion contents based on log information stored in the memory 230. The AP 210 generates combined contents by combining the log contents and the emotion contents generated based on the log information stored in memory 230. The AP 210 groups the log contents and the combined contents based on a specific reference to generate a content group. For example, the AP 210 groups the contents in a unit of one day based on a timeline. The AP 210 analyzes the emotion contents included in the content group (the emotion contents included in the combined contents included in the content group) and generates group emotion contents showing an emotional state of the entire group. The AP 210 adds the generated group emotion contents in the form of log contents to the content group.

The communication module 220 (e.g., the communication interface 160) performs a data communication with any other electronic device (e.g., the external electronic device 104 or the server 106) connected to the electronic device 200 through the network 162. The communication module 220 includes a cellular module 221, a WiFi module 223, a BT module 225, a GPS module 227, an NFC module 228, and a Radio Frequency (RF) module 229.

The cellular module 221 offers a voice call, a video call, a message service, an internet service, or the like through a communication network (e.g., LTE, LTE-A, CDMA, WCDMA, UMTS, WiBro, or GSM, etc.). Additionally, the cellular module 221 performs identification and authentication of the electronic device 200 in the communication network 162, using the SIM card 224. The cellular module 221 performs at least part of functions the AP 210 can provide. For example, the cellular module 221 performs at least part of a multimedia control function.

The cellular module 221 includes a communication processor (CP). Additionally, the cellular module 221 may be formed of SoC, for example. Although some elements such as the cellular module 221 (e.g., the CP), the memory 230, or the power management module 295 are shown as separate elements being different from the AP 210 in FIG. 2, the AP 210 may be formed to have at least part (e.g., the cellular module 221) of the above elements in an embodiment.

The AP 210 or the cellular module 221 (e.g., the CP) loads commands or data, received from a nonvolatile memory connected thereto or from at least one of the other elements, into a volatile memory to process them. Additionally, the AP 210 or the cellular module 221 stores data, received from or created at one or more of the other elements, in the nonvolatile memory.

Each of the WiFi module 223, the BT module 225, the GPS module 227 and the NFC module 228 includes a processor for processing data transmitted or received therethrough. Although FIG. 2 shows the cellular module 221, the WiFi module 223, the BT module 225, the GPS module 227 and the NFC module 228 as different blocks, at least part of them may be contained in a single Integrated Circuit (IC) chip or a single IC package in an embodiment. For example, at least part (e.g., the CP corresponding to the cellular module 221 and a WiFi processor corresponding to the WiFi module 223) of respective processors corresponding to the cellular module 221, the WiFi module 223, the BT module 225, the GPS module 227 and the NFC module 228 may be formed as a single SoC.

The RF module 229 transmits and receives data, e.g., RF signals or any other electric signals. Although not shown, the RF module 229 includes a transceiver, a Power Amp Module (PAM), a frequency filter, a Low Noise Amplifier (LNA), or the like. Also, the RF module 229 includes any component, e.g., a wire or a conductor, for transmission of electromagnetic waves in a free air space. Although FIG. 2 shows that the cellular module 221, the WiFi module 223, the BT module 225, the GPS module 227 and the NFC module 228 share the RF module 229, at least one of them may perform transmission and reception of RF signals through a separate RF module in an embodiment.

The SIM card 225_1 to 225_N may be a specific card formed of SIM and may be inserted into a slot 224_1 to 224_N formed at a certain place of the electronic device. The SIM card 225_1 to 225_N may contain therein an Integrated Circuit Card IDentifier (ICCID) or an International Mobile Subscriber Identity (IMSI).

The memory 230 includes an internal memory 232 and an external memory 234. The internal memory 232 may include, for example, at least one of a volatile memory (e.g., Dynamic RAM (DRAM), Static RAM (SRAM), Synchronous DRAM (SDRAM), etc.) or a nonvolatile memory (e.g., One Time Programmable ROM (OTPROM), Programmable ROM (PROM), Erasable and Programmable ROM (EPROM), Electrically Erasable and Programmable ROM (EEPROM), mask ROM, flash ROM, NAND flash memory, NOR flash memory, etc.).

The internal memory 232 may have the form of a Solid State Drive (SSD). The external memory 234 may include a flash drive, e.g., Compact Flash (CF), Secure Digital (SD), Micro Secure Digital (Micro-SD), Mini Secure Digital (Mini-SD), eXtreme Digital (xD), memory stick, or the like. The external memory 234 may be functionally connected to the electronic device 200 through various interfaces. The electronic device 200 may further include a storage device or medium such as a hard drive.

The memory 230 stores log information generated whenever each function of the electronic device 200 is generated. The log information includes situation recognition information, used function related information, and sensor information about the electronic device 200, including photographing by a camera, an image, a schedule, a memo, playing of media, scrap booking, a recording, a call history, message transmission/reception, position information, an SNS use history.

The memory 230 stores a program by which a method of providing contents is executable.

The sensor module 240 measures physical quantity or senses an operating status of the electronic device 200, and then converts measured or sensed information into electric signals. The sensor module 240 includes, for example, at least one of a gesture sensor 240A, a gyro sensor 240B, an atmospheric sensor 240C, a magnetic sensor 240D, an acceleration sensor 240E, a grip sensor 240F, a proximity sensor 240G, a color sensor 240H (e.g., Red, Green, Blue (RGB) sensor), a biometric sensor 240I, a temperature-humidity sensor 240J, a luminance sensor (e.g., an illumination sensor) 240K, and a UV (ultraviolet) sensor 240M. Additionally or alternatively, the sensor module 240 may include, e.g., an E-nose sensor, an electromyography (EMG) sensor, an electroencephalogram (EEG) sensor, an electrocardiogram (ECG) sensor, an infrared (IR) sensor, an iris scan sensor, or a finger scan sensor. Also, the sensor module 240 may include a control circuit for controlling one or more sensors equipped therein.

The input unit 250 includes a touch panel 252, a digital pen sensor 254, a key 256, or an ultrasonic input unit 258. The touch panel 252 recognizes a touch input in a manner of capacitive type, resistive type, infrared type, or ultrasonic type. Also, the touch panel 252 may further include a control circuit. In case of a capacitive type touch panel 252, a physical contact or proximity may be recognized. The touch panel 252 may further include a tactile layer. In this case, the touch panel 252 may offer a tactile feedback to a user.

The digital pen sensor 254 may be formed in the same or similar manner as receiving a touch input or by using a separate recognition sheet. The key 256 may include, for example, a physical button, an optical key, or a keypad.

The ultrasonic input unit 258 is a specific device capable of identifying data by sensing sound waves with a microphone 288 in the electronic device 200 through an input tool that generates ultrasonic signals, thus allowing wireless recognition. The electronic device 200 receives a user input from any external device (e.g., a computer or a server) connected thereto through the communication module 220.

The input device 250 receives emotion information from a user. The input device 250 receives each constituent element for generating the emotion contents and the group emotion contents from the user.

The display 260 includes a panel 262, a hologram 264, or a projector 266. The panel 262 may be, for example, Liquid Crystal Display (LCD), Active Matrix Organic Light Emitting Diode (AM-OLED), or the like. The panel 262 may have a flexible, transparent or wearable form. The panel 262 may be formed of a single module with the touch panel 252. The hologram 264 may show a stereoscopic image in the air using interference of light. The projector 266 may project an image onto a screen, which may be located at the inside or outside of the electronic device 200. The display 260 may further include a control circuit for controlling the panel 262, the hologram 264, and the projector 266.

The display module 260 displays the content group. The display module 260 displays the content group together when displaying a background screen image and/or a lock screen image of the electronic device 200.

The interface 270 includes, for example, a High-Definition Multimedia Interface (HDMI) 272, a Universal Serial Bus (USB) 274, an optical interface 276, or a D-subminiature (D-sub) 278. The interface 270 may be contained, for example, in the communication interface 160 shown in FIG. 1. Additionally or alternatively, the interface 270 may include, for example, a Mobile High-definition Link (MHL) interface, a Secure Digital (SD) card/Multi-Media Card (MMC) interface, or an Infrared Data Association (IrDA) interface.

The audio module 280 performs a conversion between sounds and electric signals. At least part of the audio module 280 may be contained, for example, in the input/output interface 140 shown in FIG. 1. The audio module 280 processes sound information inputted or outputted through a speaker 282, a receiver 284, an earphone 286, or a microphone 288.

The camera module 291 is a device capable of obtaining still images and moving images. The camera module 291 may include at least one image sensor (e.g., a front sensor or a rear sensor), a lens, an Image Signal Processor (ISP), or a flash (e.g., LED or xenon lamp).

The camera module 291 detects a face of the user. Accordingly, the electronic device 200 generates information on an expression of the face of the user by using the detected face of the user as the log information.

The power management module 295 manages electric power of the electronic device 200. Although not shown, the power management module 295 may include, for example, a Power Management Integrated Circuit (PMIC), a charger IC, or a battery gauge.

The PMIC may be formed, for example, of an IC chip or SoC. Charging may be performed in a wired or wireless manner. The charger IC may charge a battery 296 and prevent overvoltage or overcurrent from a charger. The charger IC may have a charger IC used for at least one of wired and wireless charging types. A wireless charging type may include, for example, a magnetic resonance type, a magnetic induction type, or an electromagnetic type. Any additional circuit for a wireless charging may be further used such as a coil loop, a resonance circuit, or a rectifier.

The battery gauge may measure the residual amount of the battery 296 and a voltage, current or temperature in a charging process. The battery 296 may store or create electric power therein and supply electric power to the electronic device 200. The battery 296 may be, for example, a rechargeable battery or a solar battery.

The indicator 297 may show thereon a current status (e.g., a booting status, a message status, or a recharging status) of the electronic device 200 or of its part (e.g., the AP 210).

The motor 298 may convert an electric signal into a mechanical vibration. Although not shown, the electronic device 200 may include a specific processor (e.g., GPU) for supporting a mobile TV. This processor may process media data that comply with standards of Digital Multimedia Broadcasting (DMB), Digital Video Broadcasting (DVB), or media flow.

Each of the above-discussed elements of the electronic device disclosed herein may be formed of one or more components, and its name may be varied according to the type of the electronic device. The electronic device disclosed herein may be formed of at least one of the above-discussed elements without some elements or with additional other elements. Some of the elements may be integrated into a single entity that still performs the same functions as those of such elements before integrated.

The AP 210 analyzes one or more elements of log data and generates one or more log contents and one or more emotion contents, combines each of the one or more log contents with one or more emotion contents generated based on the same log information, generates one or more combined contents including the emotion contents, groups the one or more log contents and the one or more combined contents to generate a content group, generates group emotion contents by using the emotion contents included in the content group, inserts the group emotion contents into the content group in the form of log contents, and the display module 260 displays the content group including the group emotion contents.

The input device 250 is configured to receive emotion data from a user. In this case, the processor 210 of the electronic device 200 generates the emotion contents and the group emotion contents by using the received emotion data.

The processor 210 may recognizes whether each of the one or more log contents includes the emotion contents generated based on the same log information, adds the recognized emotion contents to a specific field of each of the log contents, and generates the combined contents.

The display module 260 of the electronic device 200 also aligns and displays one or more log contents within the content group including the group emotion contents and the group emotion contents in order by time.

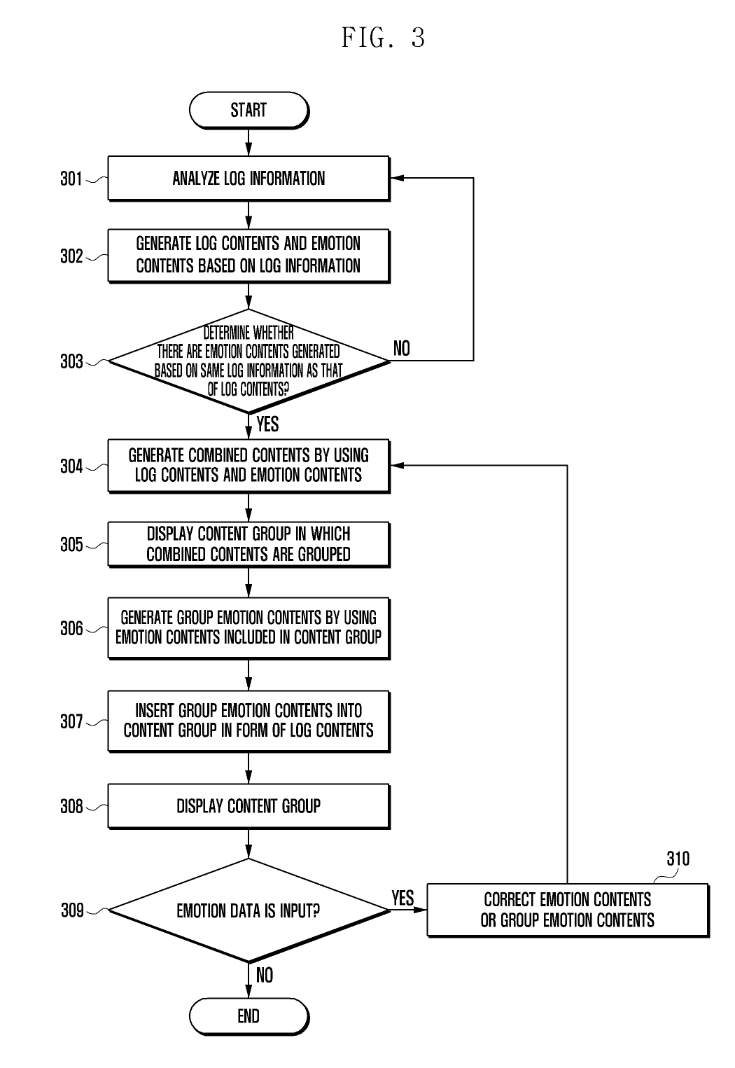

FIG. 3 is a flowchart illustrating a method of providing contents by the electronic device 200, according to an embodiment of the present invention.

At step 301, the electronic device 200 analyzes log information. The log information may contain all of the information generated and utilized while a user uses the electronic device 200. The log information may contain situation recognition information, used function related information, sensor information, and the like. For example, the log information may include camera photographing information, image addition information, schedule and event information, memo information, message reception/sending information, media play information, scrap booking information, a recording, a call history, an SNS use history, position information, and acceleration sensor information, and the like. The log information may be stored in the memory 230 of the electronic device 200.

At step 301, the electronic device 200 also recognizes the past of the user including a place, at which the user was located at a specific time, and a thing the user did by analyzing the log information.

At step 301, the electronic device 200 also extracts the log information which is meaningful to the user. For example, the electronic device 200 extracts the log information related to a specific function (for example, a message function, a call history, and/or position information) among the log information stored in the memory 230. The electronic device 200 also extracts the log information according to a condition selected by the user among the log information stored in the memory 230. In this case, the user selects a function of the electronic device 200 or various conditions, such as a generation period of the log information and sets and changes a log information extraction condition.

At step 302, the electronic device 200 generates one or more emotion contents and one or more log contents based on the log information. At step 302, the electronic device 200 also generates log contents displayable by a visual element based on the log information extracted at step 301. Here, the visual element includes an image, a color, an image frame, text, and a font style, and the visual elements may be combined to generate one visually displayable content. Further, the log contents may additionally include an audible element and various elements recognizable by the user in addition to the visual element.

For example, at step 302, the electronic device 200 also extracts the log information including a message reception history at a specific time and contents of the message, visually configures information, such as a message icon, a reception time, the message contents, and a sender, in the form of a layout, and generates a message card.

At step 302, the electronic device 200 also generates emotion contents displayable with the visual element based on the log information extracted at step 301. The electronic device 200 extracts information necessary for determining emotions of the user from the log information. The electronic device 200 generates emotion information showing an emotional state of the user based on the extracted information. The emotion information may include information relating to a mood of a user, such as “joyful”, “pleasant”, “depressed”, and “bored” indicating a basic emotional state, and “busy”, “comfortable”, and “free” indicating a state of a person. However, the emotion information is not limited thereto, and other emotion information may be added and the emotion information may be varied.

At step 302, the electronic device 200 also generates emotion information by using the position information among the log information. For example, when the log information indicates that the user is in a new place, e.g., not “home” or not in the “office,” that is, preset position information exists, the electronic device 200 generates “joyful” as emotion information according to a visit to the new place. In another example, the electronic device 200 compares a time of a stay at “home” with a time of being at an “office” by using the position information, and when the time of being at the “office” is longer than the time of the stay at “home”, the electronic device 200 generates “tired” as the emotion information.

At step 302, the electronic device 200 also generates emotion information based on the log information containing communication information containing the message reception/sending information and call reception/sending (e.g., call history) information among the log information. For example, the electronic device 200 analyzes the log information containing the communication information and confirms group information about a receiver connected by the user. When there are many people included in a group “company” among the people connected by the user, the electronic device 200 generates “busy” as the emotion information.

At step 302, the electronic device 200 also generates the emotion information based on the log information about an expression of a face of the user collected through detection of the face of the user. In this case, the electronic device 200 detects the face of the user by using the camera module 291. For example, when the user sets lock release through face detection in a lock screen, the electronic device 200 recognizes a change in an expression while the user looks at the lock screen for detecting the face and generates emotion information. In this case, the electronic device 200 generates the emotion information about the user whenever the user releases the lock screen, and recognizes a change in an emotional state of the user.

At step 302, the electronic device 200 also generates the emotion information based on the log information corresponding to interest information preset by the user. For example, the electronic device 200 determines a news article set as an interested area by the user as positive news or negative news, and when the news article of the interested area is a positive news article, the electronic device 200 generates “joyful” as the emotion information, and when the news article of the interested area is a negative news article, the electronic device 200 generates “depressed” as the emotion information. In this case, the user may set and change a specific item (for example, a related field, such as an economy field and/or entertainment field) and detailed items of the news article received by the electronic device 200 as interested information. Further, the user may set other emotion information, such as “pleasant” or “sad” to be generated as a result of the determination of the news article as a positive news article or a negative news article by the electronic device 200.

At step 302, the electronic device 200 also receives emotion information from the user (emotion data). The user may input emotion data for generating emotion information through the input device 250, and may directly input emotion information, such as “joyful” and “sad”. The electronic device 200 generates emotion contents corresponding to the received emotion information.

At step 302, the electronic device 200 also analyzes the emotion information, which is previously input by the user, according to the log information, and predicts and generates current emotion information. For example, when the user always and repeatedly inputs “joyful” as the emotion information at a specific place, the electronic device 200 generates “joyful” as the emotion information when the log information indicating that the user is in a corresponding place exists. Otherwise, the electronic device 200 displays the predicted emotion information on the display module 260, and receives an input of a confirmation from the user through the input device 250.

At step 302, the electronic device 200 also generates emotion contents corresponding to the generated emotion information. The emotion contents may be generated based on an image, a color, an image frame, text, and a font style, and/or a combination thereof.

At step 302, the electronic device 200 also generates an emoticon corresponding to the emotion information as the emotion contents. For example, when the emotion information is “joyful”, the electronic device 200 generates a “smiling sun emoticon”. For example, when the emotion information is “depressed”, the electronic device 200 generates a “rain cloud emoticon”.

At step 302, the electronic device 200 also generates a background color of an area, in which the emotion contents are displayed, according to the emotion information. In this case, the electronic device 200 generates a background color, chroma, and brightness of the emotion contents. For example, when the emotion information is a positive emotion, such as “joyful” and “pleasant”, the electronic device 200 generates the emotion contents with a bright background color having a high chroma and brightness.

At step 302, the electronic device 200 also sets a font style (for example, a font size) of the emotion contents according to the emotion information. For example, when the emotion information is a negative emotion, such as “depressed”, the electronic device 200 sets a font size of the emotion contents to be tiny, and when the emotion information is a positive emotion, such as “pleasant”, the electronic device 200 sets a font size of the emotion contents to be large.

At step 302, the electronic device 200 also generates an image frame of the emotion contents according to the emotion information. For example, when the emotion information corresponding to the log information of a picture or a video exists in the form of a tag or meta data, the electronic device 200 generates an image frame corresponding to each emotion information and generates the emotion contents in which the generated image frame is combined with an image.

At step 302, the electronic device 200 also receives each element configuring the emotion contents from the user through the input device 250. The electronic device 200 generates the emotion contents by combining the received elements. Here, when the emotion contents automatically generated by the electronic device 200 exist, the emotion contents is generated according to an input of the user.

At step 303, the electronic device 200 determines whether there are emotion contents generated based on the same log information as that of the one or more log contents. The log contents and the emotion contents may be generated based on the same log information. For example, when the log information indicating that the user was at a specific position exists, log contents showing information on the corresponding position and emotion contents showing an emotion felt at the corresponding position by the user may be generated.

At step 304, when the same log contents and emotion contents exist, the electronic device 200 generates combined contents using the log contents and emotion contents; otherwise the electronic device 200 performs step 301 again.

At step 305, the electronic device 200 displays the combined contents by using the generated contents and the emotion contents generated based on the same log information. At this step, the electronic device 200 adds the combined contents to a partial area of the log contents and generates the combined contents. The electronic device 200 adds the emotion contents to a specific field among a plurality of fields included in the log contents to generate the combined contents. For example, when a “smiley face” emoticon (emotion contents) showing the emotion information of “pleasant” exists in connection with the log contents showing that the user was in a specific region indicated with a position on a map image, the combined contents may have a form in which the “smiley face” emoticon is added to the map image showing that the user was in the specific region.

In another example, when the log contents shows that the user listened to B music that is configured by a cover image of an album of specific B music and a purple border (emotion contents) that represents the emotion information of “depressed” exist, the combined contents may have the form in which the purple border is combined to the cover image of the music album showing that the user listened to B music.

At step 305, the electronic device 200 also groups the combined contents and generates one or more content groups. In this case, the electronic device 200 groups the combined contents and the log contents together and generates the content group. At this step, the electronic device 200 generates the content group based on a specific condition. For example, the electronic device 200 groups the log contents and the combined contents listed based on a timeline in the unit of one day, and generates a content group for each date. Otherwise, the electronic device 200 groups the contents for each kind of log information (playing music, position information, call history, and the like) and generates a content group.

At step 305, the electronic device 200 also displays the generated content group based on the display module 260. The electronic device 200 enumerates and displays the contents within the content group according to a time order (based on the timeline) when displaying the content group, and also disposes and displays the same kind of contents (for example, call history related contents or multimedia play related contents) within the content group together. Further, the electronic device 200 also disposes the contents having the same emotion information together and displays the content group on the display module.

At step 306, the electronic device 200 generates group emotion contents by using one or more emotion contents included in the content group for each content group.

At step 306, the electronic device 200 also analyzes a ratio of the emotion contents included in the content group and generates group emotion contents. For example, when the quantity of emotion contents configured by an emotionless emoticon corresponding to “bored” is largest among the emotion contents included in the content group (that is, emotion contents included in the combined contents included in the content group), the electronic device 200 generates the emotionless emoticon corresponding to “bored” as the group emotion contents.

In another example, the electronic device 200 generates the group emotion contents corresponding to the emotion information by using the emotion information received from the user. In this case, the emotion information may be input from the user through the input device 250. For example, when the user inputs “bored” into the input device 250, the electronic device 200 generates the emotionless emoticon corresponding to “bored” as the group emotion contents.

In addition, at step 306, the electronic device 200 also analyzes log information and generates the group emotion contents under a specific condition similar to the method of generating the emotion contents at step 302.

At step 307, the electronic device 200 inserts the group emotion contents to the content group in the form of log contents. That is, the electronic device 200 inserts the group emotion contents into the content group in the form of log contents showing the past of the user in accordance with a separate layout. For example, when the content group is generated based on the timeline in the unit of one day, the electronic device 200 inserts the group emotion contents in the form of text, such as “it was a really overwhelming day,” into the very end or the very last part (a start point of the day or an end point of the day) of the timeline of the content group. That is, the group emotion contents show an emotion of the user and does not show the past of the user. Alternatively, the electronic device 200 may display the group emotion contents as the log contents for a thing the user did at the very beginning or the very end of the corresponding time line when displaying the content group.

The electronic device 200 stores the group emotion contents in a separate database (DB) or the memory 230, and manages the group emotion contents in the form in which the group emotion contents are mapped with each content group. When the content group is displayed on the display module, the electronic device 200 also extracts the group emotion contents mapped to the content group and displays the extracted group emotion contents together with the content group.

At step 308, the electronic device 200 displays the content group including the group emotion contents on the display module 260. At step 308, the electronic device 200 also enumerates and displays the contents within the content group according to a time order (based on the timeline), and also disposes and displays the same kind of contents (for example, call history related contents or multimedia play related contents) within the content group together. Further, the electronic device 200 also disposes the contents having the same emotion information together and displays the content group on the display module 260. In this case, the electronic device 200 displays the group emotion contents at the uppermost side and/or the lowermost side of the displayed content group. For example, when the electronic device 200 displays the content group based on the timeline, the electronic device 200 displays the group emotion contents at the uppermost side and/or the lowermost side of the content group in the form of the log contents showing the past of the user which was generated first or last.

At step 308, when the content group displayed on the display module changes, the electronic device 200 outputs a sound corresponding to the group emotion contents of the changed content group, and generates a vibration. Specifically, when the content group, grouped based on one day, is displayed on the display module 260, and a screen image, based on a content group of each date, is switched, the electronic device 200 outputs a sound corresponding to the group emotion contents of the content group of the date at which the screen image is switched. For example, when the group emotion contents of the content group showing March 2nd show “pleasant”, and a screen image is switched by scrolling the content group showing March 2nd to the content group showing March 3rd, the electronic device 200 generates a rhythmical vibration and sound feedback. Accordingly, the user may immediately confirm an emotional state of the user at a corresponding date even without confirming particular information about the content group displayed on the display module 260. However, the user may arbitrarily set whether the electronic device 200 generates a sound or a vibration.

At step 308, the electronic device 200 also analyzes an emotion level of the emotion contents included in the content group based on a time and generates a change in the emotion level, according to a time change as the emotion contents, in the form of a graph. For example, the electronic device 200 accumulates the emotion contents (or emotion information) of the combined contents for one day (or a time designated by the user) to extract an emotion level for each time zone, and displays the emotion level in a graph based on a time axis and displays a change in an emotion for one day in a graph. For example, the electronic device 200 generates a change in the emotion level for morning, afternoon, evening, and night based on one day and generates the group emotion contents in the form of a graph. In this case, the electronic device 200 recognizes emotion contents (or emotion information) generated most during the designated time as a representative emotion at a corresponding time zone and extracts the emotion level. Otherwise, the electronic device 200 sets an emotion level numerical value for each element of emotion information (e.g., “joyful”, “sad”, and “depressed”) shown by the emotion contents within the content group, and extracts an emotion level at a corresponding time zone using an average of the emotion level numerical values of the emotion information at the corresponding time zone. The electronic device 200 displays the graph connecting the extracted emotion levels and an emoticon showing the emotion level or each time zone together.

At step 308, the electronic device 200 also display the group emotion contents in the form of the graph showing a change in the emotion level on the display module 260 together with the content group, and separately displays the group emotion contents in the form of the graph showing a change in the emotion level as a background image or a lock screen image.

At step 309, the electronic device 200 receives the emotion information input from the user, and corrects the generated emotion contents and the generated group emotion contents. At this step 309, the user designates emotion contents and group emotion contents which the user desires to correct through the input device 250. Further, the user may input emotion information of the emotion contents and the group emotion contents to be corrected. When the emotion information (emotion data) of the user is input, the electronic device 200 corrects previously generated emotion contents and group emotion contents, and displays a corrected content group on the display module.

At step 309, information for correcting the group emotion contents in the form of the graph showing a change in an emotion level may be input. The input of the user may be an input of dragging a position of an emoticon on the graph and changing a degree of an emotion level at a specific point of the graph. In this case, the electronic device 200 automatically corrects the emotion contents included in the content group according to the correction of the graph.

When there is no separate input from the user at step 309, the electronic device 200 continuously displays the content group, and when an input, other than the input of the emotion information of the user, is generated, the electronic device 200 performs a function corresponding to the corresponding input.

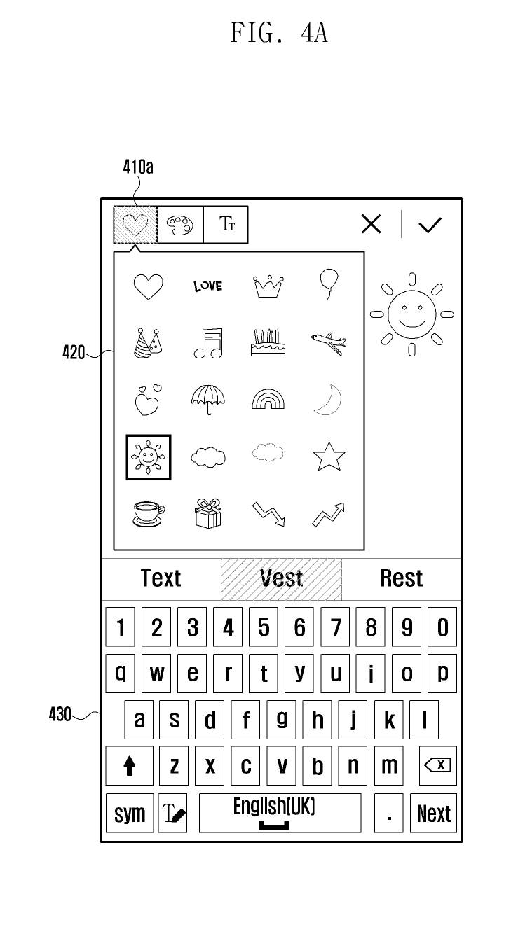

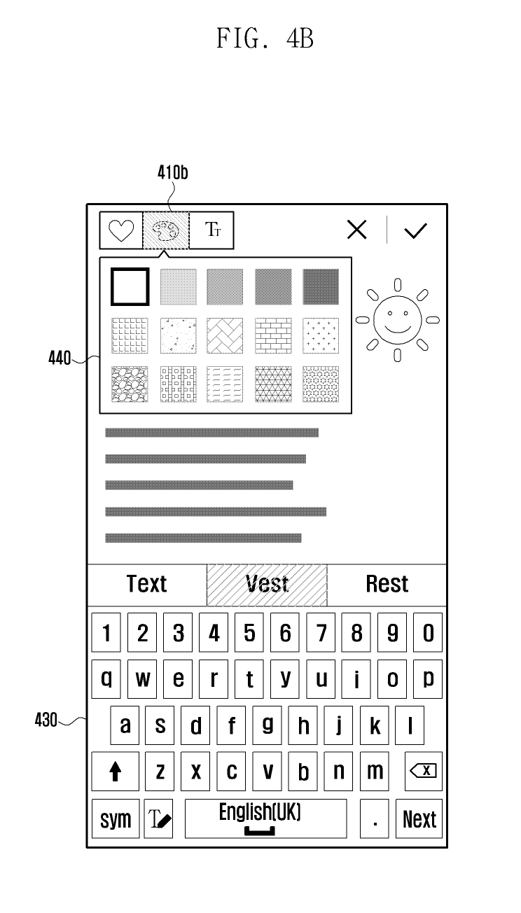

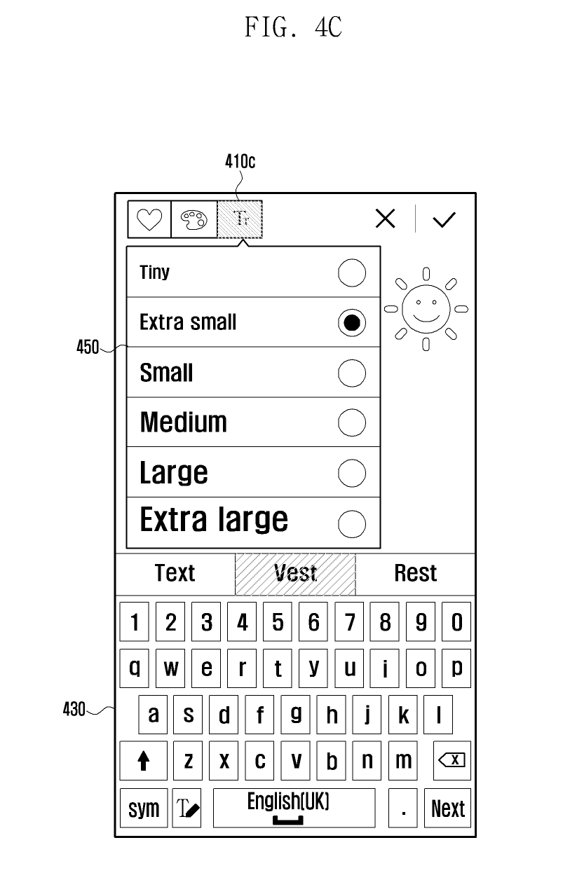

FIGS. 4A-4C are diagrams illustrating a method of providing contents by the electronic device 200, according to an embodiment of the present invention.

FIGS. 4A-4C illustrate a case where emotion information or elements of emotion contents are input from a user.

FIG. 4A is a diagram illustrating an image for setting an emoticon of emotion contents according to a selection of the user. First, the user selects an emoticon item 410a in a category of the image displayed on the display module 260. In this case, an image 420, on which available emoticons are disposed, may be displayed. Accordingly, the user selects an emoticon appropriate for showing an emotional state of the user in the emoticon image 420. In this case, the selected emoticon may be separately displayed. In this case, a keypad image 430, through which a key or a character may be input by the user, may be separately displayed at a lower end of the displayed image.

FIG. 4B is a diagram illustrating an image for receiving a background or a color element of the emotion contents from the user. The user selects a background and the color item 410b in the category displayed on the image. In this case, an image 440, on which available backgrounds are disposed, may be displayed. Accordingly, the user selects a background for showing an emotional state of the user in the background image 440. FIG. 4B also illustrates an image for selecting a color, and an image for adjusting a chroma and brightness may also be displayed.

FIG. 4C is a diagram illustrating an image for inputting a text element of the emotion contents by the user. The user selects a text item 410c in the category displayed on the image. In this case, an image 450 for selecting a font size of the text may be displayed. Accordingly, the user sets a desired text size in the displayed text size image 450. Further, a keypad image 430 for inputting text may be displayed together at a lower end of the image displayed on the display module 260.

According to the methods described herein for generating contents by the electronic device 200, it is possible to generate emotion contents configured by a combination of an emoticon, a background (including a pattern, a color, a chroma, and brightness), and a text input by the user.

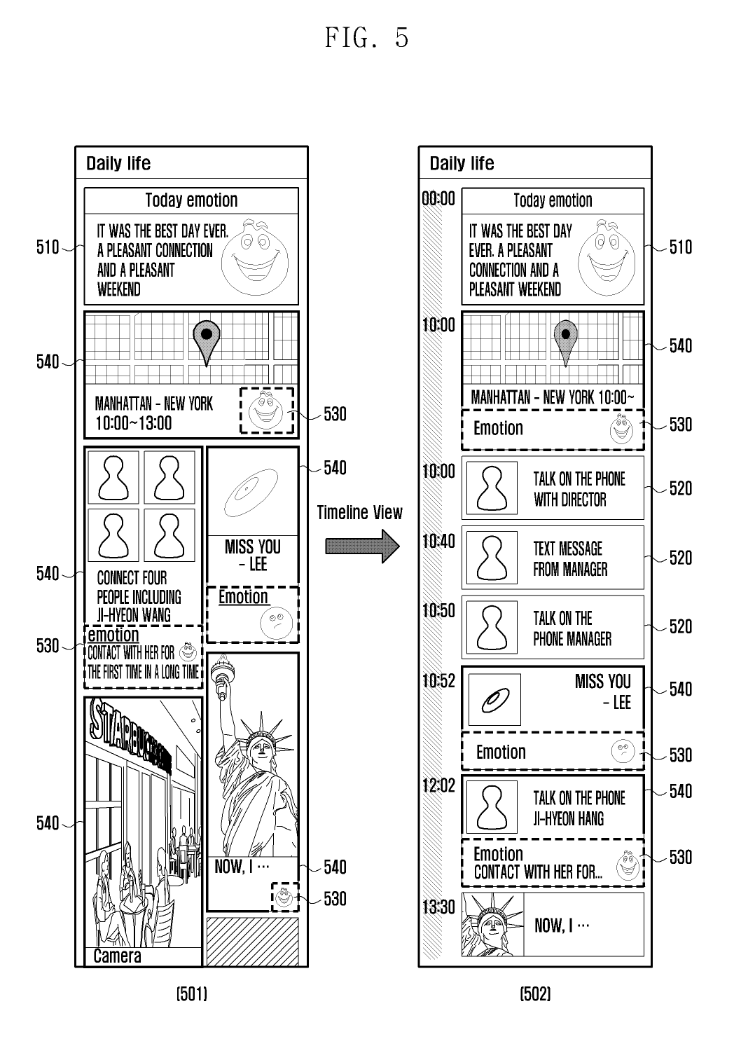

FIG. 5 is a diagram illustrating an example in which content groups 501 and 502 are displayed, according to various embodiments of the present invention.

Referring to FIG. 5, the contents groups 501 and 502 may be generated by grouping log contents 520 and combined contents 540 in the unit of one day. Emotion contents 530 are included in each combined contents 540. In this case, group emotion contents 510 may be disposed at the uppermost end of the content group displayed on the display module 260. However, a position of the group emotion contents 510 may be set and changed to another position other than the upper end.

The same kind of contents (log contents 520 and the combined contents 540) within the content group may be displayed together. For example, referring to the content group 501 illustrated on the left side of FIG. 5, an image in which contents related to a call history are grouped together and displayed is illustrated. Further, a form of a display of the content group may be switched. For example, the contents included in the content group may be switched to be displayed based on a timeline from the form on the left side to the form on the right side of FIG. 5. Referring to the content group 502 illustrated on the right side of FIG. 5, contents within the content group are disposed and displayed in a time order of one day. In this case, the group emotion contents 510 may be set as if the group emotion contents 510 are things occurring at a start time (12:00 a.m.) of a day and displayed at the uppermost end of the content group 502.

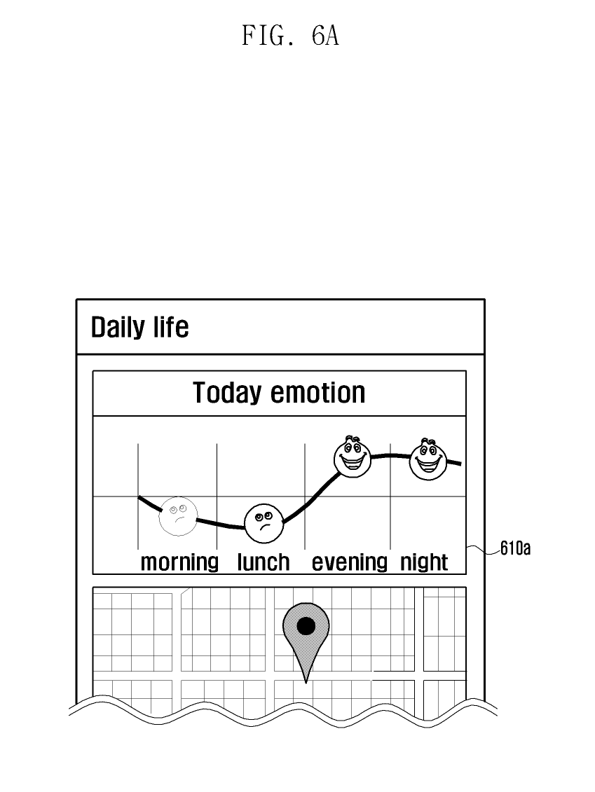

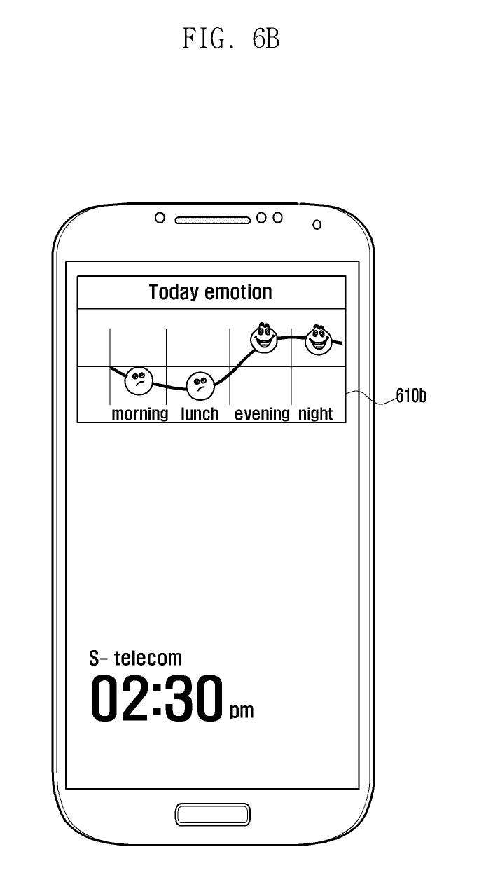

FIGS. 6A and 6B are diagrams illustrating an example of images in which a change in an emotion level is displayed in a graph, according to an embodiment of the present invention.

Referring to FIGS. 6A and 6B the emotion contents included in the group emotion contents 610a, 610b may be displayed together with other log contents within the content group, and separately displayed on a background image or a lock screen image of the display module 260 of the electronic device 200. When the group contents are generated in the unit of one day, the electronic device 200 separately displays group emotion contents 610a in the form of a graph showing a change in the emotion level generated by using the emotion contents varied for each time zone on the display module 260. For example, the user sets the group emotion contents 610a in the form of the graph showing the emotion change of one day to be displayed on the background image of the display module 260 of the portable terminal, as illustrated in FIG. 6A. Further, as illustrated in FIG. 6B, the user sets the group emotion contents 610b in the form of the graph showing the emotion change of one day illustrated in FIG. 6A to be displayed on the lock screen image of the electronic device 200. In this case, the kind of communication server, a time, and a date may be displayed together on the lock screen image of the electronic device 200. Accordingly, a user may frequently and easily confirm an emotional state of the user or a change in an emotional state.

In accordance with an embodiment of the present invention, one or more programs including commands for performing the method of providing contents may be recorded in a computer readable recording medium. Accordingly, a non-transitory computer readable medium having computer-executable instructions thereon is provided. The computer-executable instructions, when executed by a processor, cause a processing system to perform a method of providing contents that have been recorded on the electronic device 200. The method includes analyzing at least one element of log information, generating at least one emotion content and at least one log content based on the analyzed at least one element of log information, determining whether there are emotion contents generated based on the log information of the least one log content, generating at least one combined content by using the at least one log content and the determined emotion contents, and grouping the at least one log content and the at least one combined content and displaying at least one content group.

While the present invention has been shown and described with reference to certain embodiments thereof, it should be understood by those skilled in the art that many variations and modifications of the method and apparatus described herein will still fall within the spirit and scope of the present invention as defined in the appended claims and their equivalents.

What is claimed is:

1. A method of providing contents by an electronic device, comprising:
analyzing at least one element of log information;
generating at least one emotion content and at least one log content based on the analyzed at least one element of log information;
determining whether there are emotion contents generated based on the log information of the at least one log content;
generating at least one combined content by using the at least one log content and the determined emotion contents; and
grouping the at least one log content and the at least one combined content, and displaying at least one content group.

2. The method of claim 1, wherein the at least one element of log information includes situation recognition information, used function related information, and sensor information relating to the electronic device, including photographing by a camera of the electronic device, an image, a schedule, a memo, playing of media, scrap booking, a recording, a call history, message transmission/reception, position information, an Social Network Services (SNS) use history.

3. The method of claim 1, wherein generating the at least one emotion content and the at least one log content comprises generating the at least one emotion content based on at least one of an image, a color, an image frame, text, a font style, and a combination thereof.

4. The method of claim 1, wherein generating the at least one emotion content and the at least one log content comprises generating the at least one emotion content based on emotion information received from a user.

5. The method of claim 1, wherein generating the at least one emotion content and the at least one log content comprises generating emotion information based on one of a feeling and a state of a user that is based on log information and generating emotion contents corresponding to the emotion information.

6. The method of claim 5, wherein generating the at least one emotion content and the at least one log content comprises generating the emotion information based on log information including an expression of a face of the user collected through detection of the face of the user.

7. The method of claim 5, wherein generating the at least one emotion content and the at least one log content comprises generating the emotion information based on log information including position information about the user.

8. The method of claim 5, wherein generating the at least one emotion content and the at least one log content comprises generating the emotion information based on log information including communication information including message reception/sending information and call reception/sending information.

9. The method of claim 5, wherein generating the at least one emotion content and the at least one log content comprises generating the emotion information based on log information corresponding to information preset by the user.

10. The method of claim 1, further comprising generating group emotion contents by using at least one emotion content included in the at least one content group;
inserting, in the form of log contents, the generated group emotion contents into the at least one content group; and
displaying the at least one content group including the group emotion contents on a display module.

11. The method of claim 10, wherein displaying the at least one content group including the group emotion contents comprises grouping the at least one log content and the at least one combined content for each date in a unit of one day, and displaying the at least one content group.

12. The method of claim 10, wherein generating the group emotion contents comprises generating the group emotion contents corresponding to emotion information by using the emotion information received from a user.

13. The method of claim 10, wherein displaying the at least one content group comprises, when the at least one content group displayed on the display module is changed, outputting a sound corresponding to group emotion contents of the changed content group, and generating a vibration.

14. The method of claim 10, wherein displaying the at least one content group comprises analyzing emotion levels of the at least one emotion content included in the at least one content group based on a time, and displaying a change in the emotion level according to a time change in a graph.

15. The method of claim 10, further comprising:
receiving emotion information from a user and correcting the generated emotion contents and the generated group emotion contents.

16. An electronic device, comprising:
a processor configured to analyze at least one element of log information and generate at least one log content and at least one emotion content, combine the generated at least one emotion content based on the log information of the at least one log content, generate at least one combined content including emotion contents, group the at least one log content and the at least one combined content, generate a content group, generate group emotion contents by using emotion contents included in the generated content group, and insert the generated group emotion contents into the generated content group in the form of log contents; and
a display module configured to display the generated content group including the generated group emotion contents on the display module.

17. The electronic device of claim 16, further comprising:
an input device configured to receive emotion data from a user,
wherein the processor generates the emotion contents and the group emotion contents by using the received emotion data.

18. The electronic device of claim 16, wherein the processor is configured to recognize whether there are emotion contents generated based on the log information of the at least one log content and add the recognized emotion contents to a specific field of the at least one log content to generate the at least one combined content.

19. The electronic device of claim 16, wherein the display module aligns and displays the at least one log content and the group emotion contents within the content group including the group emotion contents.

20. A non-transitory computer readable medium having computer-executable instructions which, when executed by a processor, cause a processing system to perform a method of providing contents that have been recorded on an electronic device, the method comprising:
analyzing at least one element of log information;
generating at least one emotion content and at least one log content based on the analyzed at least one element of log information;
determining whether there are emotion contents generated based on the log information of the least one log content;
generating at least one combined content by using the at least one log content and the determined emotion contents; and
grouping the at least one log content and the at least one combined content and displaying at least one content group.
